(19) United States
(12) Patent Application Publication
(10) Pub. No.: US 2002/0065854 A1
(43) Pub. Date: May 30, 2002

(54) Automated medical diagnosis reporting system

(76) Inventor: Jennings Pressly, Greenville, SC (US)

Correspondence Address: Frances Barnes Elliott, Esq., Dority & Manning, P.A., P.O. Box 1449, Greenville, SC, 29602-1449, US

(21) Appl. No.: 09/725,791

(22) Filed: Nov. 29, 2000

(51) Int. Cl. G06F 17/00

(52) U.S. Cl. 707/530; 707/104.1

(57) ABSTRACT

The present invention discloses a medical records and diagnostic reporting system which allows physicians to access patient information and associated procedure reports, including image data, while composing a diagnosis. The system provides the physician stored standard or customized diagnoses as templates and means for altering selected templates or transcribing new information through dictation or textual data entry. Additionally, the reporting system provides access to and data transfer from various outside medical information sources. Finally, the system generates diagnosis reports automatically upon conclusion and disseminates reports providing a number of transmission modes.

### BACKGROUND OF THE INVENTION

The present invention relates to an improved automated system for reporting medical records and associated diagnostic information. More particularly, the invention relates to a system which allows medical personnel to quickly and easily associate patient administrative data with standard or customized diagnostic information including dictated reports and imaging data.

Automated medical records systems have been designed to allow the input and maintenance of patient information for use in scheduling appointments and medical procedures. A typical system enables medical personnel to enter patient demographic information such as name and social security number along with a doctor's name and a scheduled appointment.

Prior art systems have included a listing of recommended procedures to be performed at a scheduled exam. Sometimes in combination with imaging data such as an X-ray, the doctor uses the results of procedures to complete a diagnosis.

Many doctors begin with a skeleton report which contains a standard diagnosis for a given condition. The doctor may then modify or customize the diagnosis based on what he or she observed in the examination itself or based on previously entered data or images from the examination. Images such as X-rays from the patient's examination and differential diagnoses of similar patients may also be considered as the doctor composes his diagnosis.

Current systems for incorporating diagnostic information from a number of different sources are very time-consuming for medical personnel. For a given medical condition, a patient may be required to undergo a number of procedures and be seen by a number of different medical personnel. Additionally, more than one doctor might be called upon to complete a diagnosis.

Further, those doctors often draw from a wide range of medical information sources, including their own experiences, to arrive at the best diagnosis possible.

Accordingly, it can be seen that a need exists for an automated medical records and diagnosis system which allows physicians to view the details of all procedures recommended and performed for a given patient, including any resulting graphical data. Further, a need exists for such an automated system which allows physicians to quickly and efficiently collate diagnostic data and contemporaneously compose a diagnosis, providing the capability to incorporate the physician's own notes with a wide range of outside medical information sources.

### SUMMARY OF THE INVENTION

The present invention recognizes and addresses the foregoing disadvantages, and others, of prior art construction and methods. Accordingly, it is an object of the present invention to provide an improved automated system for supplying doctors with comprehensive information needed to complete a medical diagnosis for a particular patient. More particularly, it is an object of the present invention to provide an automated medical records and diagnosis system which associates and allows efficient access to patient demographic information, the details of ordered procedures, imaging data, and diagnostic information.

It is also an object of the present invention to maintain accurate scheduling information about patient examinations and recommended procedures.

It is an additional object of the present invention to allow imaging data to be viewed simultaneously with procedure reporting information.

It is still a further object of the present invention to allow a doctor to maintain personalized standard diagnoses for a given condition and to easily access and edit the standard diagnoses as needed.

It is still a further object of the present invention to allow a doctor to dictate his or her diagnosis into the automated system while viewing patient history information and any imaging data available and to generate and disseminate a report contemporaneously.

It is still a further object of the present invention to allow a doctor to choose and draw from a number of outside medical information sources.

It is still a further object of the present invention to provide diagnostic reports incorporating a doctor's dictated diagnosis, procedure results including image data, and language from outside medical sources.

Additional objects and advantages of the invention will be set forth in part in the following description, or may be obvious from the description, or may be learned through practice of the invention.

Some of these objects are achieved by the design of a diagnosis reporting system having a patient records database, means for associating medical procedures with patient records, and means for developing a diagnosis report through a variety of input and editing methods. A diagnosis can be developed using standard diagnosis templates from a catalog of standard diagnoses, dictated customizing information, typed customizing information, and information received from external medical sources.

The patient records database includes patient demographic data entered into the system by clerical personnel. In a preferred embodiment, each patient record is associated with one or more medical procedure records as those procedures are ordered by medical personnel. In a preferred embodiment, the database also stores medical personnel records with information on various levels of medical personnel. In that embodiment, each medical procedure record would be associated with the record of at least one member of the medical personnel.

In addition to allowing data entry and storage of textual data into the database, the diagnosis reporting system of the present invention also includes an image capture component for the retrieval of image data, such as X-rays. In a preferred embodiment, each retrieved image is associated with at least one of the ordered medical procedures and as such is assigned to the corresponding medical procedure record.

In a preferred embodiment, a physician will associate a diagnosis with a medical procedure by first selecting a patient record for display. The medical procedure records associated with that patient as well as any image data associated with the medical procedures are also displayed by the diagnosis reporting system. In a preferred embodiment, access to the various levels of the database is restricted based on the security level of the member of the medical personnel accessing the system.

In a preferred embodiment, each medical procedure record includes a status field which is edited to indicate the status of the medical procedure, for example, whether the procedure is still pending or has been completed. The diagnosis reporting system includes an update component which updates real-time the edited status field for any medical procedure record which is currently displayed.

The diagnosis reporting system includes a catalog of standard diagnoses and a detailed menu for accessing that catalog. In one embodiment, the menu into the catalog uses an index of body parts, allowing a diagnosis to be chosen based on the body part affected. In another embodiment, the menu allows selection from the catalog by medical condition. Upon selection of a standard diagnosis, the selected diagnosis is displayed along with the associated medical procedure. The physician may then edit the selected diagnosis using a regular or voice driven word processor.

Additionally, in a preferred embodiment, the diagnosis reporting system includes a speech recognition component allowing the physician to dictate information into a standard diagnosis or a blank diagnosis field. Such dictated data may then be further edited using word processing fuctions.

In another preferred embodiment, the standard or dictated diagnosis may be further enhanced by accessing an external source of medical information and retrieving data from that external source. Some examples of external sources are compact discs containing information from medical treatises, and the wide variety of information available over the Internet. This information retrieved from external sources may be inserted into a blank diagnosis field or inserted into a selected standard diagnosis or previously edited diagnosis. The resulting text may then be edited further using a word processor.

When a physician has concluded building his diagnosis from the various means available, the diagnosis reporting system allows the storage of the resulting diagnosis into the catalog of standard diagnoses or into other storage as the physician's personal customized diagnosis.

In a preferred embodiment, medical personnel may build reports, selecting data from the patient records database from patient records, personnel records, medical procedure records, and including standard or customized diagnoses as well as retrieved image data. Completed reports may then be transmitted automatically at the time of conclusion from the system in a variety of ways. For example, reports may be transmitted via facsimile, via e-mail, or to a standard printer.

The accompanying drawings, which are incorporated in and constitute a part of this specification, illustrate the described embodiments of the invention and, together with the description, serve to explain the principles of the invention.

### BRIEF DESCRIPTION OF THE DRAWINGS

A full and enabling disclosure of the present invention, including the best mode thereof and directed to one of ordinary skill in the art, is set forth in the specification, which makes reference to the appended drawings, in which:

FIG. 1 is a data flow chart showing the components of a diagnosis reporting system designed in accordance with the present invention;

FIG. 2 is a computer monitor screen view of one embodiment of a data entry screen for the patient and personnel component of the diagnosis reporting system of FIG. 1;

FIG. 3 is a computer monitor screen view of one embodiment of a data entry screen for procedure order component of the diagnosis reporting system of FIG. 1;

FIG. 4 is a computer monitor screen view of one embodiment of a screen for the report building component of the diagnosis reporting system of FIG. 1;

FIG. 5 is a computer monitor screen view of another aspect of one embodiment of a screen for the report building component of the diagnosis reporting system of FIG. 1;

FIG. 6 is a computer monitor screen view of another aspect of one embodiment of a screen for the report building component of the diagnosis reporting system of FIG. 1;

FIG. 7 is a computer monitor screen view of another aspect of one embodiment of a screen for the report building component of the diagnosis reporting system of FIG. 1;

FIG. 8 is an object description diagram of the diagnosis reporting system of FIG. 1.

Repeat use of reference characters in the present specification and drawings is intended to represent same or analogous features or elements of the invention.

### DETAILED DESCRIPTION OF THE PREFERRED EMBODIMENT

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

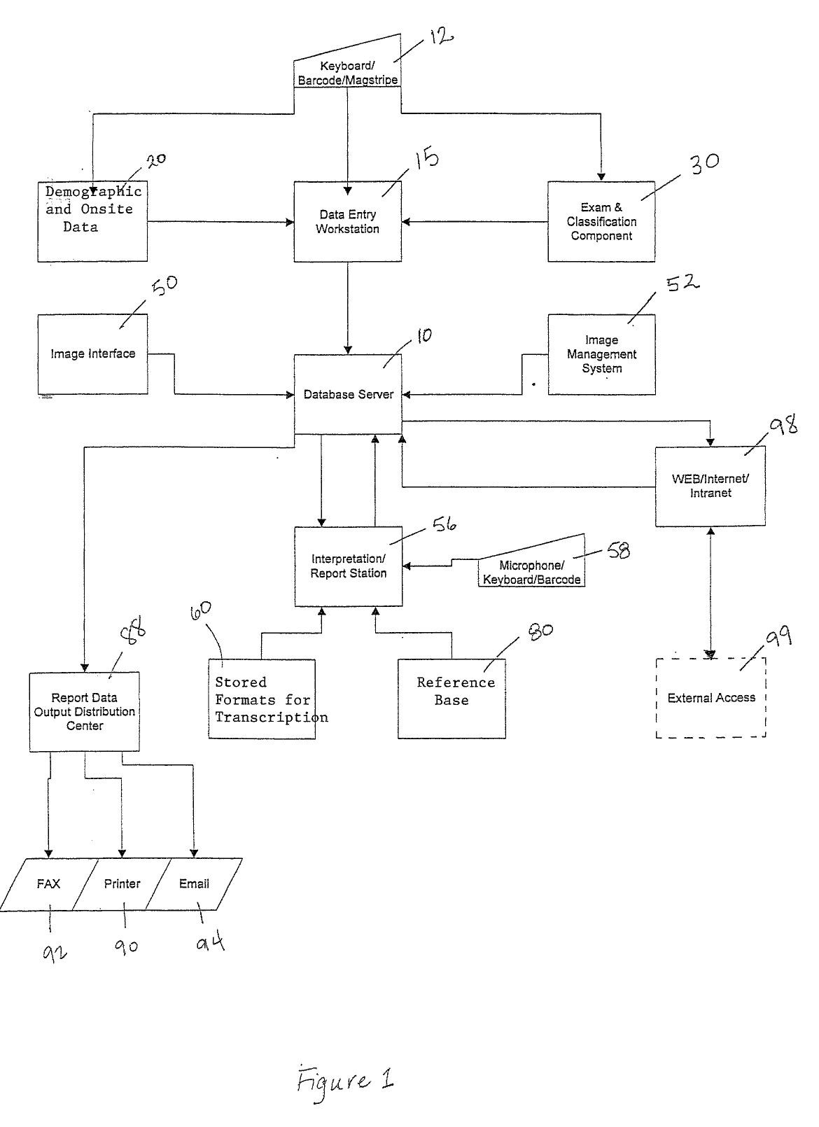

The present invention is concerned with an improved automated medical diagnosis reporting system which allows physicians to quickly and conveniently develop a diagnosis report and associate it with a patient's medical records, incorporating diagnostic information from a variety of sources. Accordingly, FIG. 1 depicts a presently preferred embodiment of an automated medical diagnosis reporting system in the form of a flow diagram.

The diagnosis reporting system of the present invention incorporates a patient records database to maintain information on patients, medical personnel, and exams and procedures. In a preferred embodiment, the relationships among the various information records are maintained using a relational database such as Sql Server. As shown in FIG. 1, the diagnosis reporting system includes a database server 10 for managing the flow of information to and from the database. As shown, data entry is accomplished using the data entry component 15 which may be accessed by one or more data entry devices 12 including a keyboard, barcode reader, and/or magnetic stripe reader.

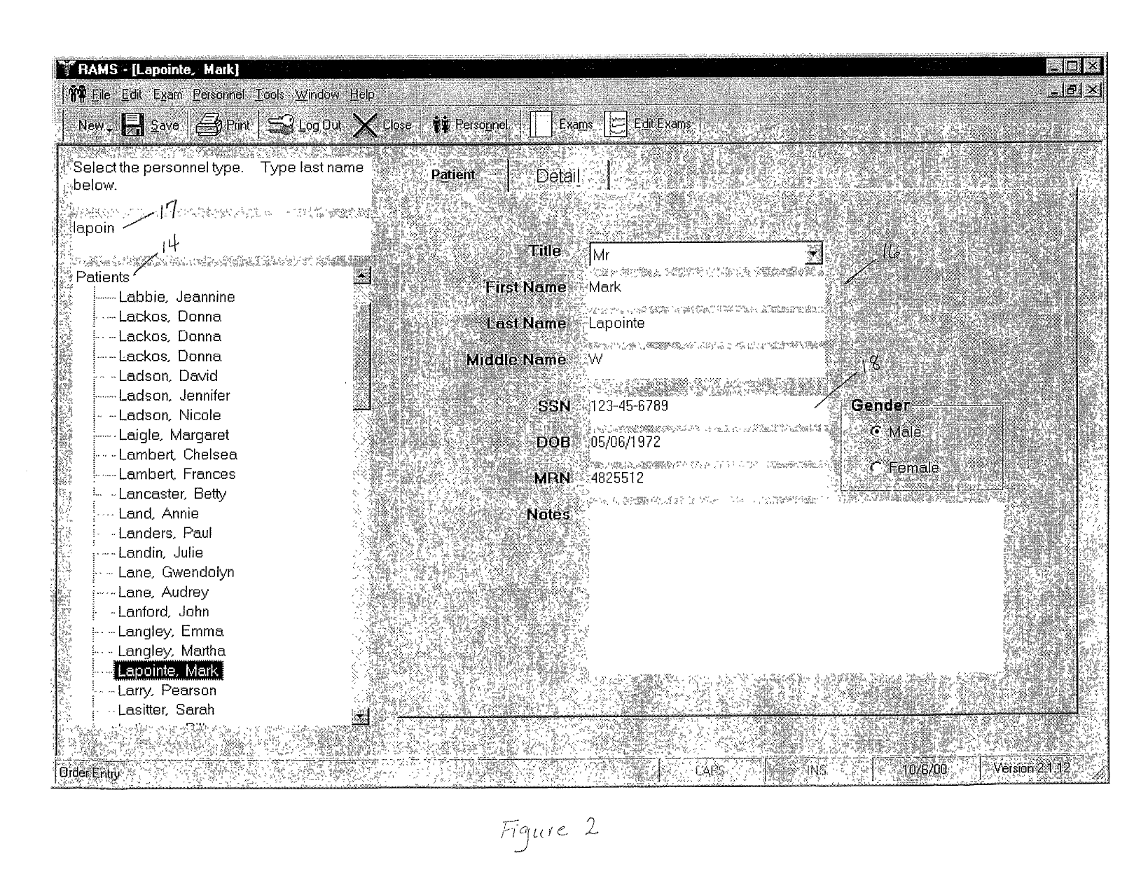

The demographic and onsite data component 20 allows entry and editing of patient and personnel records. Patient and personnel information may be entered into the diagnosis reporting system at the data entry workstation 15. Alternatively, because many medical offices have existing medical record systems, the system of the present invention provides compatibility with various hardware and software platforms to allow access to previously stored data. FIG. 2 shows one embodiment of a data entry screen for the demographic and onsite data component 20. The user first selects a personnel type from a list (not shown) which includes patients 14. The user may then enter demographic information such as name 16 and social security number 18, for storage in the patient records database. Alternatively, the user may use a record ID such as last name 17 to access and retrieve an existing record from the patient records database. The user may then edit the retrieved record as necessary.

Similarly, exam information may be entered into the patient records database using the exam and classification component 30 of the diagnosis reporting system as shown in FIG. 1. The exam and classification component ensures that each exam is associated with a given patient and is assigned at least one procedure as discussed below.

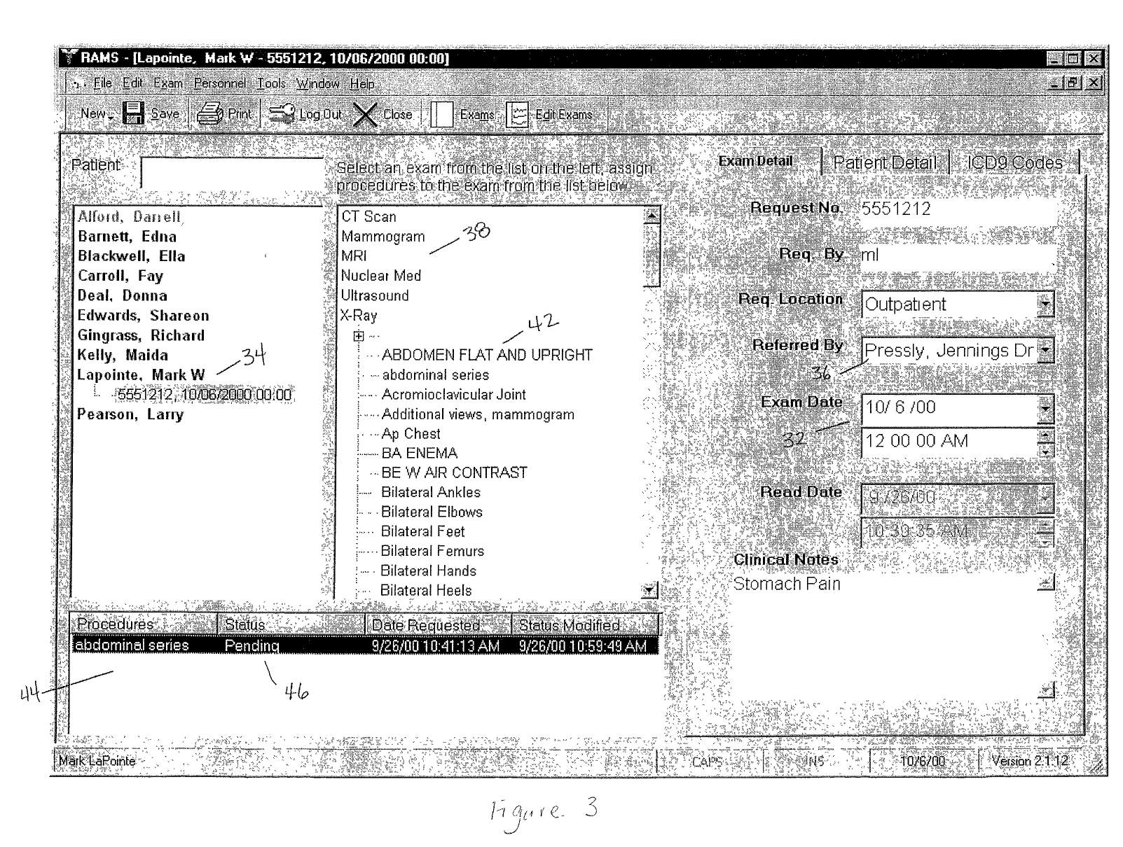

As shown in detail in FIG. 3, an exam is essentially an appointment date and time 32 associated with a given patient 34 which has been requested by a physician or other medical personnel 36. FIG. 3 shows a preferred embodiment of a data entry screen for entering the exam information into the patient records database.

FIG. 3 also illustrates the assignment of procedures to a given exam. In a preferred embodiment, the user may first select an exam from the exam list field 38. The user will be shown a list of applicable procedures in the procedure list field 42, and may then select the procedures to be performed for the selected patient 34 during the selected exam. These procedures will then be displayed in the selected procedures field 44 along with the current status 46 of each procedure.

When the medical procedures for a given exam have been completed, a physician or password enabled medical personnel may then begin building a diagnosis based on the results of various procedures. In a preferred embodiment, the physician will select the relevant patient record which will be displayed along with current exam and procedure information for that patient as in FIG. 3. Thus, the physician has access to exam and procedure information which may be used in the diagnosis report.

In particular, the physician may check the status field 46 for each relevant procedure to ensure that each procedure has been completed. In a preferred embodiment, the exam and classification component 30 includes an update component which updates the status field 46 for any medical procedure record currently displayed in the system anytime that status field alters or is edited by medical personnel. The update component similarly updates a timer on the Interpretation/Report Workstation 56 which displays new patient and exam information for the appropriate physician.

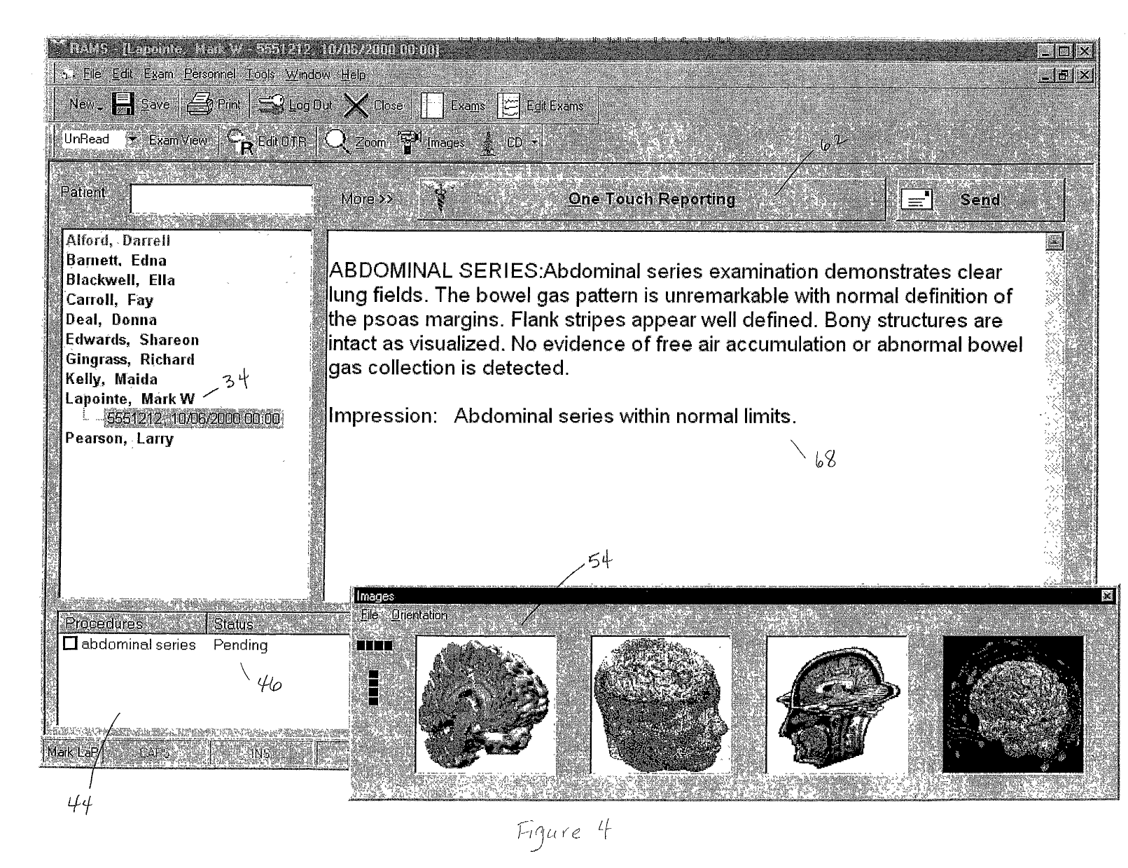

Additionally, a physician building a diagnosis report has access to any image data associated with the displayed medical procedure records. In a preferred embodiment, the diagnosis reporting system includes an imaging interface 50 which allows access to imaging software outside the system. X-rays are a common example of the image data stored by the imaging software. The imaging interface software 50 allows the physician to retrieve the stored image data 54 and display the images along with the exam and procedure information, as shown in FIG. 4.

Alternatively, the diagnosis reporting system includes a video graphics card and associated software to allow the collection of image data on site. The image management system 52 provides the capability to manipulate and view collected image data.

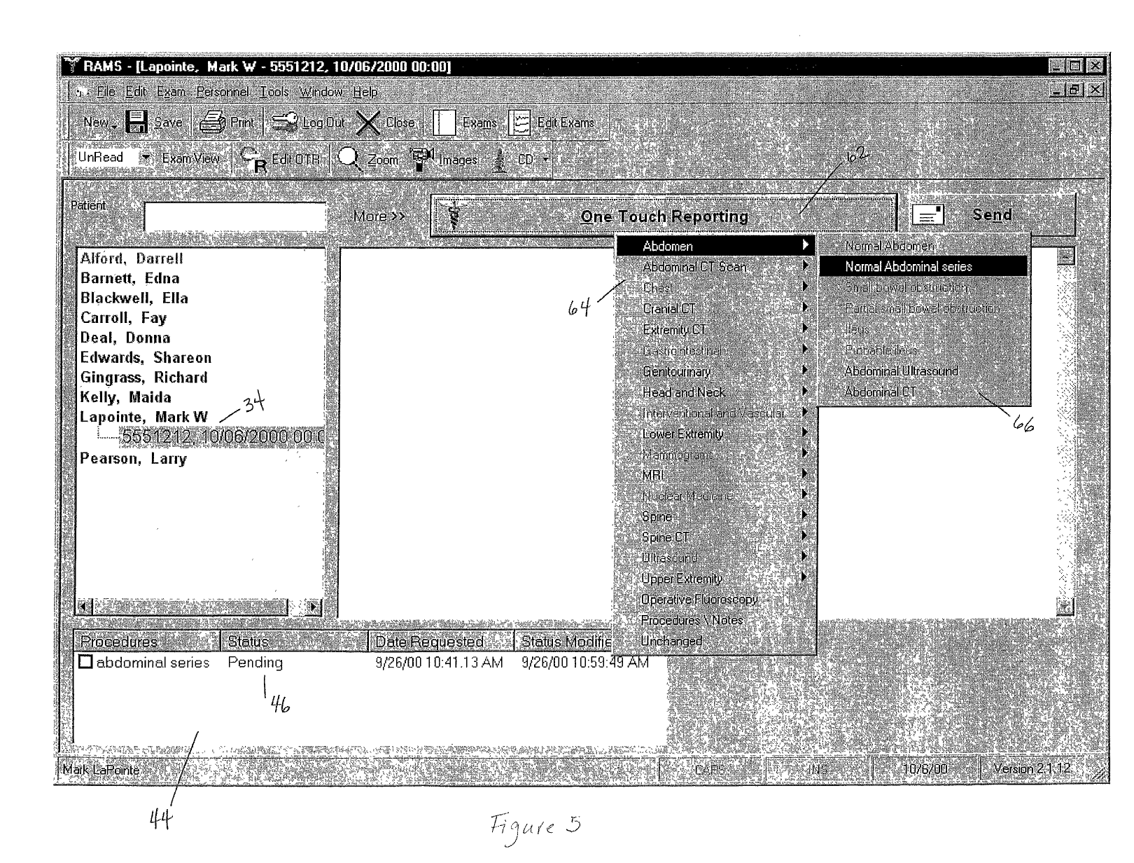

In building the diagnosis report, the physician has a number of different tools available. The Interpretation/Report Station 56 accepts input from a physician through a number of input devices 58 including a microphone, a keyboard, and/or a barcode reader. The stored formats for transcription component 60 allows the selection of a standard diagnosis from a catalog of standard diagnoses which the physician may use as the basis for the report or, in the simplest case, as the whole of the report. As shown in FIG. 5, selection of the One Touch Reporting icon 62 displays a detailed menu or index 64 for accessing the catalog of standard diagnoses. In the embodiment shown, the index 64 consists of a list of parts of the body which may be affected along with specific tests. The index 64 has multiple levels 66 which become more and more specific. In another embodiment, the menu may allow selection by medical condition.

Having completed a selection from the menu, the physician will be shown the diagnosis stored for the given selection. Such diagnosis may be a standard diagnosis for the system or may be standard as customized by the physician using the system and resaved as his personal form diagnosis for the particular selection. The physician may then edit the displayed diagnosis using a regular word processor or using dictated data as discussed below.

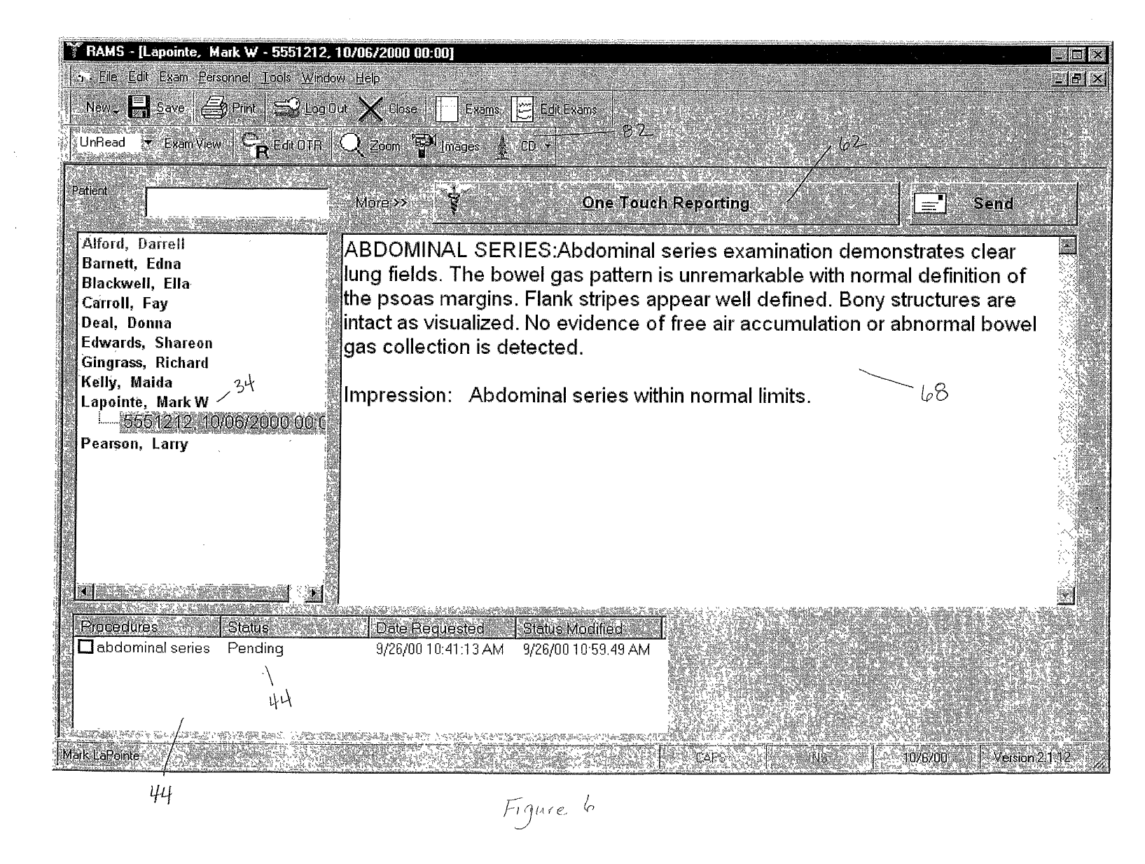

FIG. 6 illustrates one embodiment of the data entry and display screen a physician might use with the present invention in building a diagnosis report. In addition to patient information and the selected procedures field 44, the reporting detail area 68 displays the body of the diagnosis report. As discussed above, the body of the report may be retrieved using the stored formats component 60. Alternatively, some or all of the report may be dictated by the physician at the Interpretation/Report Station 56 via microphone 58.

Speech recognition software which retrieves and translates voice data is known in the art. Some examples which are compatible with the diagnosis reporting system of the present invention are IBM ViaVoice and Dragon NaturallySpeaking. The diagnosis reporting system uses interface software, such as DigitalDictate, to run the speech recognition drivers. The combination of the voice drivers and the interface software allows voice data spoken into a microphone 58 to be translated into textual data and displayed in the reporting detail field 68 of the display screen. By using the cursor to indicate where dictated data should be inserted, the physician building the report may also edit the information in the reporting detail field 68 using the Interpretation/Report Station 56.

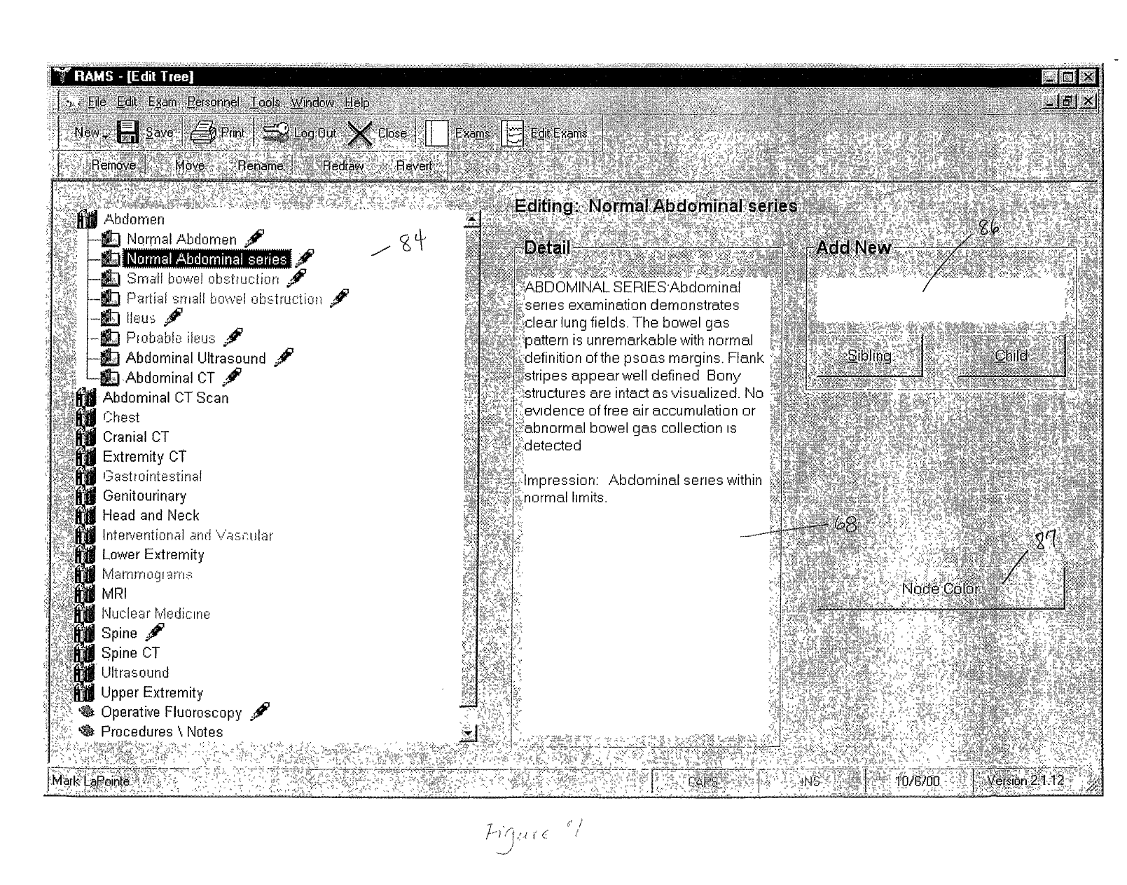

In a preferred embodiment, the reference base component 80 is another tool available to medical personnel for building a diagnosis report. Medical personnel may select the tree icon 82 to access external sources of medical information. FIG. 7 illustrates one embodiment of the reference base component 80 in use in the diagnosis reporting system. The reference base component 80 includes interface software for accessing a variety of stored information. For example, if the external source is in the form of a compact disc containing reference material, the software would interface with a compact disc reader to retrieve the relevant information for display to the user.

Selection of the tree icon 82 displays to the user a menu of available medical information 84, similar to the menu presented by the stored formats component 60. The menu may allow selection by topic as shown and may include incrementally more detail. When the desired information has been retrieved, it is displayed in the reporting detail field 68. The retrieved information may then be reviewed by the medical personnel building the report and edited using a regular word processor or with dictated data. Information retrieved from an external source may also be inserted into an existing diagnosis in the reporting detail field 68.

When a diagnosis report has been completed to the satisfaction of the physician or other medical personnel preparing the diagnosis, the user has the option of resaving the finished report for subsequent access. As shown in FIG. 7, the physician may select the Add New field 86 to include the completed diagnosis into the catalog of standard diagnoses or other storage as his or her personal customized diagnosis. The Node Color button 87 allows color coding of report formats for more efficient selection.

Upon completion of the diagnosis, the report may be disseminated automatically. The user should first determine what form the report output should take. In the embodiment shown FIG. 1, the user may select to print the report to a specified printer, or to fax or email the report to other medical personnel. The Report Data Output Distribution Center 88 can interface with each device or mode of output: printer 90, fax 92 and email 94. The fax server allows concurrent transmission of reported data to referral physicians or treatment sites.

Reports and other information stored within the diagnosis reporting system are also available to users outside the system via a network link 98 as shown in FIG. 7. The network link component provides external access to users without system workstations 99 to retrieve reporting and other data, as allowed by security codes, through the Internet or another network link, by using a browser.

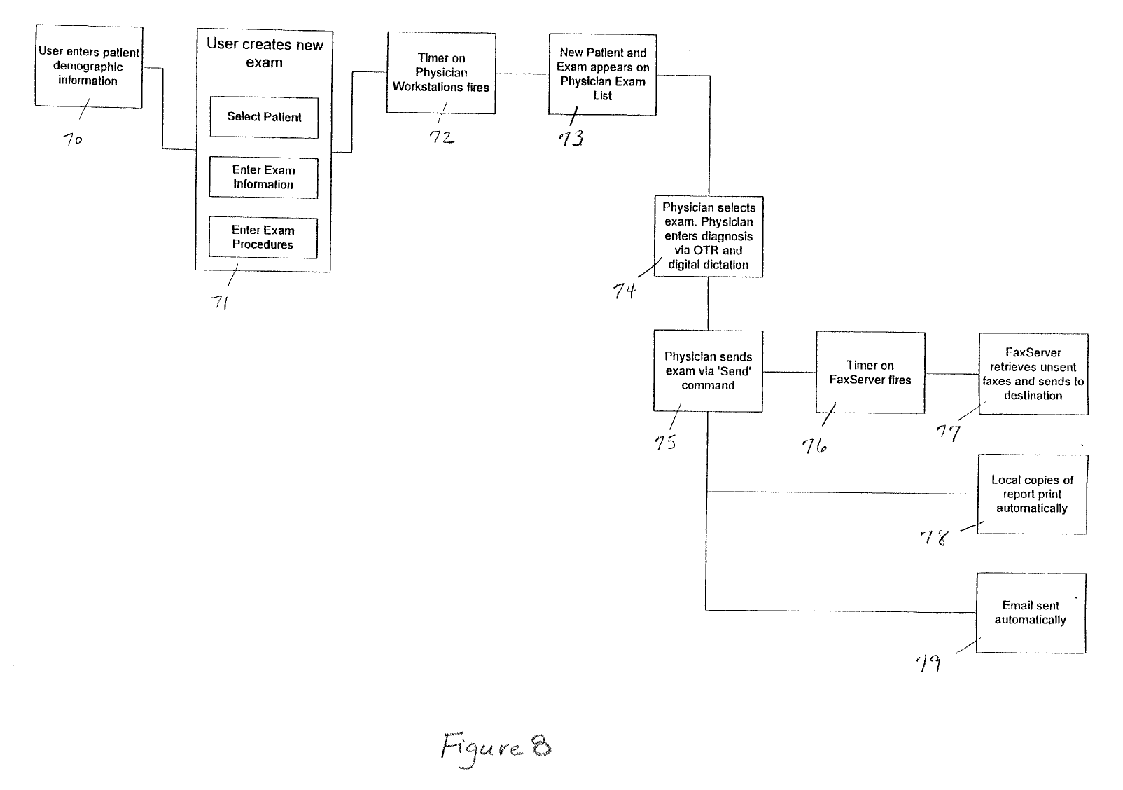

The object description diagram of FIG. 8 represents the flow of the software driving the diagnosis reporting system beginning with accepting patient demographic data from the user 70. The system then receives exam and procedure information and associates it with a patient selected by the user 71. The software then notifies the appropriate physician's workstation 72 and displays patient and exam information 73. The system allows the user to select an exam and enter a diagnosis 74 using the various tools described above. The system accepts a “Send” command from the user indicating the diagnosis report is complete and ready for transmission 75. The software notifies the Fax Server 76 and initiates the sending of all pending faxes 77. The system automatically prints the report on local printers 78 and transmits the report by e-mail 79.

It can thus be seen that the present invention provides a diagnosis reporting system which enables medical personnel to efficiently access all relevant patient and procedure data, and provides a variety of interfaces for building a diagnosis report which combines the physician's own thoughts and observations with the existing body of medical diagnostic material in a simple and effective manner.

While preferred embodiments of the present invention have been described above, it is to be understood that any and all equivalent realizations of the present invention are included within the scope and spirit thereof. Thus, the embodiments depicted are presented by way of example only and are not intended as limitations upon the present invention. While particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

What is claimed is:

1. An automated medical diagnosis reporting system comprising:
a patient demographic component for maintaining patient records;
a first selection means for selecting a patient record for display;
a medical procedure component for maintaining medical procedure records;
a personnel component for maintaining medical personnel records;
a first assignment means for assigning at least one said medical procedure record to said selected patient record;
a second assignment means for assigning at least one said personnel record to each said medical procedure record;
a display component for displaying at least said selected patient record and each said assigned medical procedure record;
an image capture component for the retrieval of image data;
a third assignment means for assigning said image data to at least one said medical procedure record;
an image display component for displaying said image data; and
a diagnosis component for associating diagnostic information with at least one said medical procedure record.

2. The automated medical diagnosis reporting system of claim 1, said diagnosis component further comprising:
a diagnosis display field for displaying said diagnostic information;
a catalog of standard diagnoses;
a second selection means to allow the selection of at least one said diagnosis from said catalog of standard diagnoses;
a first insertion means for inserting said selected diagnosis into said diagnosis display field;
a dictation component to allow the entry of voice data;
a speech recognition component for translating said voice data into textual dictated data;
a second insertion means for inserting dictated textual data into said diagnosis display field;
access means for accessing an external source of medical information;
an external capture component for the retrieval of external textual data from said external source of medical information;
a third insertion means for inserting external textual data into said diagnosis display field; and
a word processing component for editing textual data in said diagnosis display field.

3. The diagnosis reporting system of claim 1, further comprising:
a reporting component for producing reports to include said diagnostic information, said image data, and information from said patient records, said personnel records, and said medical procedure records; and
a transmission component for transmitting said reports.

4. The diagnosis reporting system of claim 3, where said transmission component transmits by facsimile.

5. The diagnosis reporting system of claim 3, where said transmission component transmits using email.

6. The diagnosis reporting system of claim 2, wherein said second selection means allows selection of said standard diagnosis by body part.

7. The diagnosis reporting system of claim 2, wherein said second selection means allows selection of said standard diagnosis by medical condition.

8. The diagnosis reporting system of claim 2, further comprising a standard diagnosis entry component allowing textual entry of a customized diagnosis into said catalog of standard diagnoses.

9. The diagnosis reporting system of claim 8, wherein said standard diagnosis entry component allows insertion of said external textual data retrieved using said access means into said catalog of standard diagnoses.

10. The diagnosis reporting system of claim 8, wherein said standard diagnosis entry component allows insertion of said diagnosis display field into said catalog of standard diagnosis.

11. The diagnosis reporting system of claim 1, further comprising a security component to restrict access to said patient records, said personnel records, said medical procedure records, and said diagnostic information.

12. The diagnosis reporting system of claim 1, each said medical procedure record having a status field.

13. The diagnosis reporting system of claim 12, further comprising:
means for editing said status field to indicate the status of said medical procedure records; and
an update component for updating said edited status field for each said displayed medical procedure record.

14. An automated medical diagnosis reporting system comprising:
a records database component for maintaining patient records;
a diagnosis component for maintaining a catalog of standard diagnoses;
an image capture component for the retrieval of image data;
a first selection means for selecting at least one of said patient records for display;
a second selection means for selecting at least one said standard diagnosis for display as a selected medical diagnosis simultaneously with said patient record;
a third selection means for selecting said image data for display;
an image display component for the display of said image data simultaneously with said patient record and said selected medical diagnosis;
a speech recognition component for translating dictated voice data into textual data;
dictation display means for displaying said dictated data;
a first insertion means for inserting said dictated data into said selected medical diagnosis;
word processing means for editing said selected medical diagnosis;
a reporting component for formatting reports combining said patient records, said selected diagnosis, and said image data; and
a transmission component for transmitting said reports.

15. The diagnosis reporting system of claim 14, further comprising:
access means for accessing an external source of medical information;
an external capture component for the retrieval of external textual data from said external source of medical information; and
a second insertion means for inserting said external textual data into said selected medical diagnosis.

16. An automated medical diagnosis reporting system comprising:
a records database component for maintaining patient records;
a diagnosis component for maintaining a catalog of standard diagnoses;
an image capture component for the retrieval of image data;
a first selection means for selecting at least one of said patient records for display;
a second selection means for selecting at least one said standard diagnosis for display as a selected medical diagnosis simultaneously with said patient record;
a third selection means for selecting said image data for display;
an image display component for the display of said image data simultaneously with said patient record and said medical diagnosis;
access means for accessing an external source of medical information;
an external capture component for the retrieval of external textual data from said external source of medical information;
a first insertion means for inserting said external textual data into said selected medical diagnosis;
word processing means for editing said selected diagnosis;
a reporting component for formatting reports combining said patient records, said selected diagnosis, and said image data; and
a transmission component for transmitting said reports.

17. The diagnosis reporting system of claim 16, further comprising:
a speech recognition component for translating dictated voice data into textual data;
dictation display means for displaying said dictated data; and
a second insertion means for inserting said dictated data into said selected medical diagnosis.

18. The diagnosis reporting system of claim 16, wherein said external source of medical information is a compact disc reader.

19. The diagnosis reporting system of claim 16, wherein said external source of medical information is the Internet.

20. An automated method of reporting a medical diagnosis comprising the steps of:
entering patient demographic data;
entering information on medical personnel;
entering examination information associated with said patient data;
entering orders for procedures made by said medical personnel and associated with said patient data and said examination information;
displaying said patient data and information about said procedures on a monitor screen for viewing by a physician;
retrieving and display imaging data associated with said procedures;
displaying a menu to allow a selection of a standard diagnosis from a catalog by said physician;
retrieving a diagnosis from said catalog using said menu selection;
editing said diagnosis using dictation;
formatting a report including said patient data, said imaging data, and said edited diagnosis; and
transmitting said report.

21. The method of reporting a medical diagnosis of claim 20, wherein said menu lists said standard diagnoses by body part.

22. The method of reporting a medical diagnosis of claim 20, wherein said menu lists said standard diagnoses by medical condition.

23. The method of reporting a medical diagnosis of claim 20, further comprising the step of saving the edited diagnosis in said catalog.

24. The method of reporting a medical diagnosis of claim 20, further comprising the steps of:
accessing an external source of medical information;
retrieving information from said external source; and
editing said diagnosis using said external information.

25. The method of reporting a medical diagnosis of claim 24, further comprising the step of saving the edited diagnosis in said catalog.
